(19) United States
(12) Patent Application Publication
(10) Pub. No.: US 2017/0291292 A1
(43) Pub. Date: Oct. 12, 2017

(54) Adjustable Handle for Cleaning and Coating Application Devices

(71) Applicant: Giandomenico Busato, Calistoga, CA (US)

(72) Inventor: Giandomenico Busato, Calistoga, CA (US)

(21) Appl. No.: 15/093,368

(22) Filed: Apr. 7, 2016

(51) Int. Cl. B25G 1/06; B05C 1/08; B25G 1/10

(52) U.S. Cl. CPC B25G 1/06; B25G 1/102; B05C 1/08

(57) ABSTRACT

A handle assembly for a cleaning device such as a broom with an internal weight whose position is adjustable by the user to change the center of gravity of the cleaning device for ease of use. As an option, the handle assembly may be attached to a broom head, mop head, or other cleaning device, or a coating application device such as a paint roller, or floor wax applicator.

### CROSS-REFERENCES TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

### 1. Field of the Invention

The present invention relates generally to cleaning or coating application devices with long handles. More specifically, the present invention relates to a cleaning or coating application device wherein the handle includes an adjustable center of gravity to reduce operator fatigue and improve ease of use of the device.

### 2. Description of the Related Art

Items used for cleaning or applying coatings to floors, such as brooms, mops and wax application devices generally have a cleaning or application head attached to a handle of appropriate length that aids the operator in the sweeping, mopping, or application process without requiring extensive bending or kneeling. Similarly, items such as paint rollers, brushes and dusters that may be used to clean or apply coatings to walls or ceilings, or to clean items above the operator's head, have a cleaning or application head attached to a such a handle. Handles for such items are used by placing one hand at the furthest end from the cleaning or application head and one hand at approximately the mid-section of the length of the handle for maximum control of the head location. Such handles are generally designed to be as light as possible to reduce the strength required while using the device. Although a lighter weight handle may aid in reducing the strength required for use, it does not reduce operator fatigue which can occur due to the repetitive motion while in use.

Pat. No. 9,102,049 discloses a cleaning or coating application device wherein a stiffened handle includes an adjustable center of gravity to reduce operator fatigue and improve ease of use of the device. Although this resolves the issue of operator fatigue while using the device, the adjustment mechanism on that invention employs a threaded shaft that requires the user to repeatedly rotate the hilt portion relative to the long shaft to position the weight within the handle. In practice, this becomes quite cumbersome as the twisting action requires so many turns to move the weight substantially that the user may become fatigued. In addition, the user may accidentally reposition the weight while using the device due to normal twisting action that may occur when holding the hilt in one hand and the long shaft in the other.

The present invention addresses these issues by providing an adjustment mechanism that allows the operator to change the center of gravity of the device without twisting the hilt relative to the shaft. In addition, the present invention effectively locks the weight in the desired position on the shaft to prevent accidental movement. Yet another advantage of the present invention is a reduction in manufacturing costs due to a unique shaft configuration that reduces the number of components required, and that can be inexpensively manufactured from plastic.

### BRIEF SUMMARY OF THE INVENTION

The present invention is a Handle that has an adjustable center of gravity attached to a Cleaning or Coating Application Head wherein the Cleaning or Coating Application Head is intended to be used on surfaces or items that are difficult to reach without bending, kneeling, or using a ladder. In a preferred embodiment, the Cleaning or Coating Application Head has a threaded, or other removable connection method, to the Handle so that the same Handle may be used with a variety of Cleaning or Coating Application Heads. In other embodiments, one Cleaning or Coating Application Head, such as a broom head, mop head, wax applicator, paint roller, duster, squeegee, or the like, is permanently attached to the Handle.

The Handle consists of a Hilt that is affixed to an Outer Shaft and an Adjustable Weight that can be positioned in any location on the Outer Shaft. The Adjustable Weight has a Flexible Securing Part with tabs that mate with holes on the Outer Shaft. The Flexible Securing Part can be pulled back by the user so the tabs disengage and the Adjustable Weight can be moved up or down the shaft. Once positioned as desired, the operator simply pushes the Flexible Securing Part into position, engaging the tabs and securing the position of the Adjustable Weight on the Outer Shaft.

### BRIEF DESCRIPTION OF THE SEVERAL VIEWS OF THE DRAWINGS

A more complete understanding of the present invention may be derived by referring to the detailed description and claims when considered in connection with the figures, wherein like reference numbers refer to similar items throughout the figures and:

FIG. 1 is a front view of an embodiment of the present invention, shown with a broom head installed.

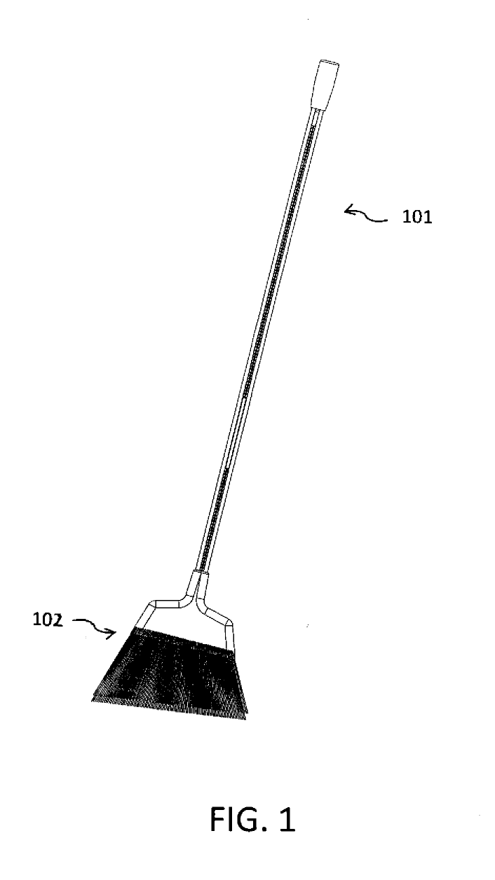

FIG. 2 is a perspective view of the invention showing the primary components separated.

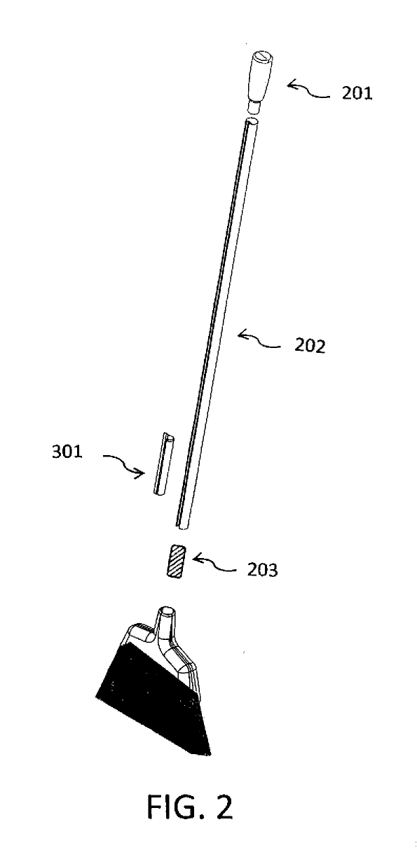

FIG. 3 shows a top view of the Outer Shaft component, a top view of the Adjustable Weight, and a top view of the Adjustable Weight installed inside the Outer Shaft.

FIG. 4 provides a perspective view of the Adjustable Weight showing the Flexible Securing Part with tabs and a close-up front view of the Adjustable Weight installed in the Outer Shaft.

### DETAILED DESCRIPTION OF THE INVENTION

In the following detailed description of the invention, reference is made to the accompanying drawings which form a part of the disclosure and, which show by way of illustration, and not of limitation, specific embodiments by which the invention may be practiced. The drawings, the foregoing discussion, and the following description are exemplary and explanatory only, and are not intended to limit the scope of the invention or its application in any manner.

The present invention is a device with a Handle 101, an Adjustable Weight 301, and an optional Cleaning or Coating Application Head 102 that may be any type of cleaning or coating application head such as a broom head, mop head, wax applicator, paint roller, duster, squeegee, or the like. In a preferred embodiment, the Cleaning or Coating Application Head 102 is attached to the Handle 101 via a threaded connection so that it is replaceable and different Cleaning or Coating Application Heads 102 may be installed for different uses. In an alternate embodiment, the connection is fixed with glue to prevent rotation, or using any other appropriate attachment method.

The Handle 101 consists of a Hilt 201, an Outer Shaft 202, and an Attaching Part 203. The Hilt 201 is preferably made from plastic, and has a smooth outer surface and a shape that is comfortable for the average user to grip. The Hilt 201 is permanently fixed to the top of the Outer Shaft 202 with glue or by other appropriate means. The Attaching Part 203 is permanently fixed to the bottom of the Outer Shaft 202 with glue or by other appropriate means and is of appropriate size to fit into the Cleaning or Coating Application Head 102. In a preferred embodiment, the Attaching Part 203 is threaded so that it can mate with a threaded portion of the Cleaning or Coating Application Head 102. In other embodiments, the Attaching Part 203 may have a smooth outer surface and of appropriate external diameter to be press-fitted into the Cleaning or Coating Application Head 102. In yet another alternate embodiment, the Attaching Part 203 and the Outer Shaft 202 may be made from a single piece of material.

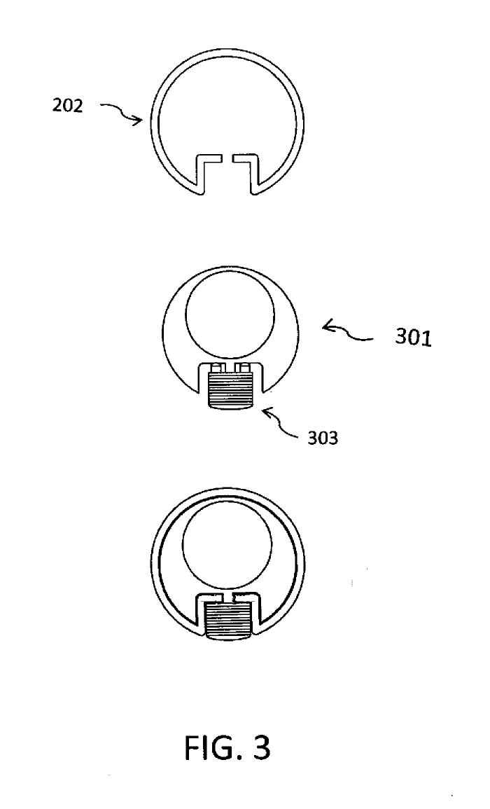

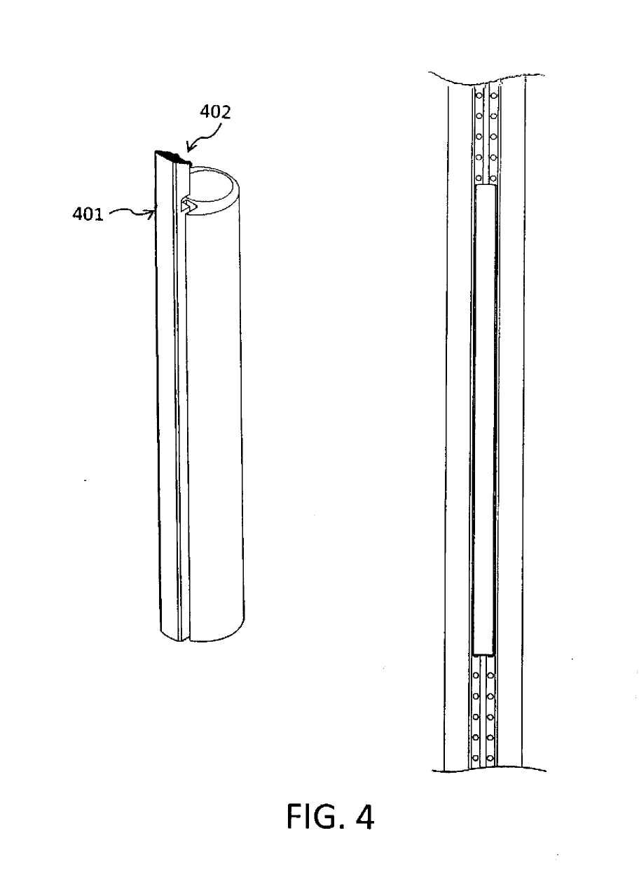

The Outer Shaft 202 is preferably made of stiff plastic and is configured such that it forms an incomplete ring with an indented section that is designed to match the Adjustable Weight 301 as shown in FIG. 3. The indented section of the Outer Shaft 202 has a series of holes that are sized to accept tabs on the Adjustable Weight 301 as shown in FIG. 4. In a preferred embodiment, there are two sets of holes on the Outer Shaft 202 and two tabs on the Adjustable Weight 301, however there may be only a single set of holes or two or more rows of tabs on the Adjustable Weight 301 depending on the strength of the material used for the tabs and the weight of the Adjustable Weight 301.

The Adjustable Weight 301 is generally in the shape of a hollow cylinder with an oblong projection as shown in FIG. 4. The cylinder portion is sized such that it fits inside the Outer Shaft 202, The cylinder portion preferably has a hole through the center to allow air passage and prevent cavitation when it is slid to a higher or lower position on the Outer Shaft 202. The oblong projection is sized to match the indent on the Outer Shaft 202 and is connected to the cylinder portion by a long thin section that fits between the ends of the Outer Shaft 202 ring.

The top of the oblong projection of the Adjustable Weight 301 has an Indented Section 401 that creates a flex point so that the top of the oblong projection becomes a Flexible Securing Part 402. The Flexible Securing Part 402 is preferably ridged on the top surface to create a gripping area for the user. The Flexible Securing Part 402 has at least one tab at the top that fits into a mating hole on the Outer Shaft 202. The user can pull back the Flexible Securing Part 402 to remove its tab engagement with any hole or set of holes on the Outer Shaft 202 and reposition the Adjustable Weight 301 on the Outer Shaft 202 by moving the Adjustable Weight 301 upward or downward and then pushing the Flexible Securing Part 402 back to engage the tab or tabs in a different hole or set of holes. There are preferably two tabs on the Flexible Securing Part 402 and two sets of matching holes on the Outer Shaft 202, but there may be only one tab and series of holes or more tabs and holes depending on the strength of the materials chosen. The Adjustable Weight 301 may be made from one component or from more than one component that are glued or otherwise fixed together for ease of manufacture.

Many modifications and variations of this invention may be made without departing from its spirit and scope, as will be appreciated by those skilled in the art. The specific embodiments described herein are offered by way of example only. The embodiments were chosen and described in order to best explain the principles of the invention and its practiced applications.

What is claimed is:

1. A handle assembly with an adjustable center of gravity suitable for attachment to a cleaning or coating application device head, said handle assembly comprising:
(a) a hollow oblong casing having a top end, a bottom end, an internal shape, and a series of holes, said bottom end configured to be installed in a cleaning or coating application device head such that said device head is secured to said hollow oblong casing, and where said internal shape is an incomplete circle with an indented rectangular section with a space in the center of the indented rectangular section, and where the series of holes is located in the indented rectangular section and extends from the top end to the bottom end of the hollow oblong casing;
(b) a hilt securely attached to the top end of said hollow oblong casing, said hilt configured to be gripped by an operator;
(c) a weight installed in the hollow oblong casing having an external configuration, and a top end, said external configuration with an incomplete external diameter matching the internal shape of the hollow oblong casing, and a “T”-shaped cross-section such that the slim portion of the “T” fits in the space in the center of the indented rectangular section of the hollow oblong casing and the wide portion of the “T” fits into the indented rectangular section of the the hollow oblong casing, and wherein the top end has at least one tab that fits into the holes in the hollow oblong casing, and wherein the top end is flexible such that the top end can be bent backwards far enough to disengage the tab or tabs from the holes in the hollow oblong casing.

2. The handle assembly in accordance with claim 1, attached to a cleaning device head selected from broom, squeegee, mop, duster.

3. The handle assembly in accordance with claim 1, attached to a coating application device head selected from paint roller, floor wax applicator, stain applicator.
